(19) United States
(12) Patent Application Publication
(10) Pub. No.: US 2025/0373130 A1
(43) Pub. Date: Dec. 4, 2025

(54) METHOD FOR MANUFACTURING STATOR OF AXIAL GAP MOTOR AND STATOR OF AXIAL GAP MOTOR

(71) Applicant: SHINANO KENSHI CO., LTD., Ueda-shi,Nagano (JP)

(72) Inventor: Koichi ICHIKI, Nagano (JP)

(73) Assignee: SHINANO KENSHI CO., LTD., Ueda-shi,Nagano (JP)

(21) Appl. No.: 19/044,206

(22) Filed: Feb. 3, 2025

(30) Foreign Application Priority Data
May 28, 2024 (JP) 2024-086511

(51) Int. Cl. H02K 15/085; H02K 1/16; H02K 15/142; H02K 21/24

(52) U.S. Cl. CPC H02K 15/085; H02K 1/16; H02K 15/142; H02K 21/24

(57) ABSTRACT

A method, of manufacturing a stator of an axial gap motor, includes preparing a first substrate including a first hole in which a first coil is disposed, a second substrate including a second hole in which a second coil is disposed, the second substrate being stacked on the first substrate such that the second hole at least partially overlaps the first hole, and a blocking member being stacked on the second substrate such that the blocking member blocks the second hole from a side opposite to the first substrate, and integrating the first and second substrates, the first and second coils, and the blocking member by injecting a mold resin into the first and second holes from a side of the first substrate after the preparing.

### CROSS-REFERENCE TO RELATED APPLICATION

This application is based upon and claims the benefit of priority of the prior Japanese Patent Application No. 2024-086511, filed on May 28, 2024, the entire contents of which are incorporated herein by reference.

### BACKGROUND

### (i) Technical Field

The present disclosure relates to a method for manufacturing a stator of an axial gap motor and a stator of an axial gap motor.

### (ii) Related Art

A stator of an axial gap motor includes a substrate and coils disposed on the substrate (for example, see Japanese Utility Model Application Publication No. Sho 59-013082).

It is conceivable to secure the strength of the stator by integrating the substrate and the coils with a mold resin. However, in this case, the substrate and the coils need to be placed in a dedicated mold. Further, after a mold resin is cured, the stator needs to be released from the mold. Thus, the manufacturing processes are complicated, and the manufacturing cost may increase.

### SUMMARY

According to an aspect of the present disclosure, there is provided a method of manufacturing a stator of an axial gap motor, including: preparing a first substrate including a first hole in which a first coil is disposed, a second substrate including a second hole in which a second coil is disposed, the second substrate being stacked on the first substrate such that the second hole at least partially overlaps the first hole, and a blocking member being stacked on the second substrate such that the blocking member blocks the second hole from a side opposite to the first substrate; and integrating the first and second substrates, the first and second coils, and the blocking member by injecting a mold resin into the first and second holes from a side of the first substrate after the preparing.

According to another aspect of the present disclosure, there is provided a stator of an axial gap motor, including: a first substrate including a first hole in which a first coil is disposed; a second substrate including a second hole in which a second coil is disposed, the second substrate being stacked on the first substrate such that the second hole at least partially overlaps the first hole; a blocking member overlapped with the second substrate so as to block the second hole from a side opposite to the first substrate; and a sealing resin portion filled in the first and second holes so as to integrate the first and second substrates, the first and second coils, and the blocking member.

### BRIEF DESCRIPTION OF THE DRAWINGS

FIG. 1 is a cross-sectional view of an axial gap motor;

FIG. 2 is a front view of the stator;

FIG. 3 is a front view of the stator with a sealing resin portion omitted;

FIG. 4 is a front view of the stator, in which the sealing resin portion and a reinforcing plate are omitted;

FIG. 5 is a sectional view taken along the line A-A in FIG. 2; and

FIG. 6A is a view illustrating a method of manufacturing the stator, and FIG. 6B is a view illustrating an integrating process.

### DETAILED DESCRIPTION

### [Schematic Configuration of Axial Gap Motor]

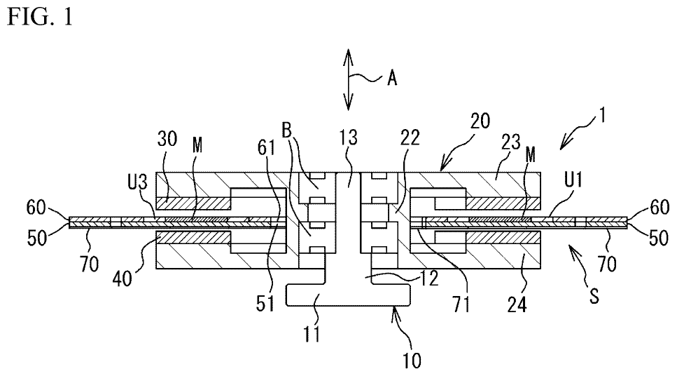

FIG. 1 is a cross-sectional view of an axial gap motor 1. FIG. 1 schematically illustrates the axial gap motor 1. The axial gap motor 1 includes a support shaft 10, a yoke 20, magnetic pole portions 30 and 40, and a stator S. The support shaft 10 rotatably supports the yoke 20. The yoke 20 and the magnetic pole portions 30 and 40 correspond to a rotor. The support shaft 10 includes a flange portion 11, a step portion 12, and a thin shaft portion 13. The step portion 12 has a smaller diameter than the flange portion 11. The thin shaft portion 13 has a smaller diameter than the step portion 12. Two bearings B are held by the thin shaft portion 13. The yoke 20 includes a cylindrical portion 22 and flange portions 23 and 24. The flange portions 23 and 24 are each in a flange shape. The flange portions 23 and 24 are separated from each other in an axial direction A. The stator S includes a printed circuit board 50, a reinforcing plate 60, a blocking member 70, and a plurality of coils. The stator S is disposed between the flange portions 23 and 24. Openings 51, 61, and 71 for allowing the support shaft 10 are formed in the center of the printed circuit board 50, the reinforcing plate 60, and the blocking member 70, respectively.

The magnetic pole portion 30 is provided on a surface of the flange portion 23 facing the stator S. The magnetic pole portion 40 is provided on a surface of the flange portion 24 facing the stator S. Each of the magnetic pole portions 30 and 40 is an annular permanent magnet. The surfaces of the magnetic pole portions 30 and 40 facing the stator S are magnetized to have polarities alternately different in a circumferential direction. In the present embodiment, each of the magnetic pole portions 30 and 40 has eight poles in the circumferential direction. Each of the magnetic pole portions 30 and 40 may be a plurality of permanent magnets arranged in the circumferential direction. In this case, the surfaces of the plurality of permanent magnets facing the stator S are also magnetized to have polarities alternately different in the circumferential direction.

A plurality of coils, which will be described in detail later, are held by the printed circuit board 50 and the reinforcing plate 60. These coils face the magnetic pole portions 30 and 40 via gaps in the axial direction A. By controlling the energization state of these coils, the yoke 20 rotates with respect to the support shaft 10 in accordance with the magnetic force generated between the coils and the magnetic pole portion 30 and between the coils and the magnetic pole portion 40. The stator S is held at its outer peripheral end by a holder (not illustrated), and is not rotatable relative to the yoke 20.

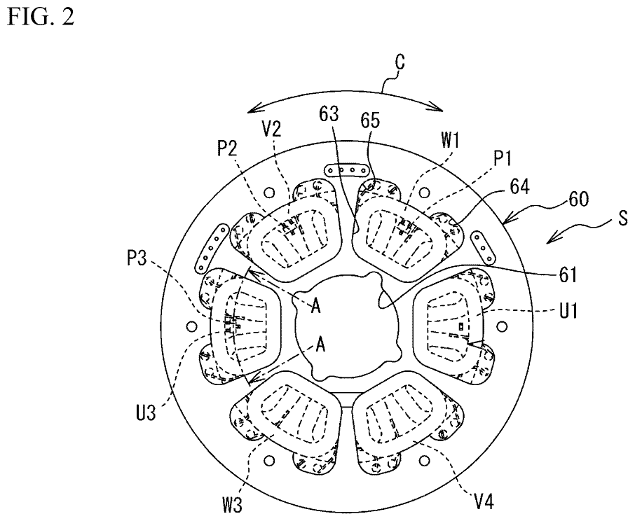

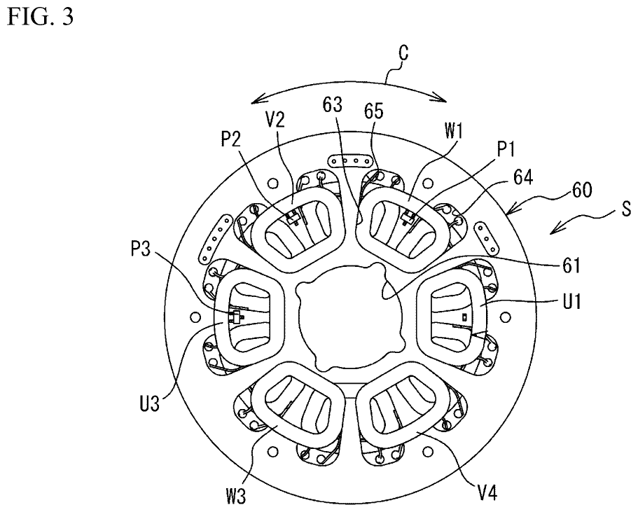

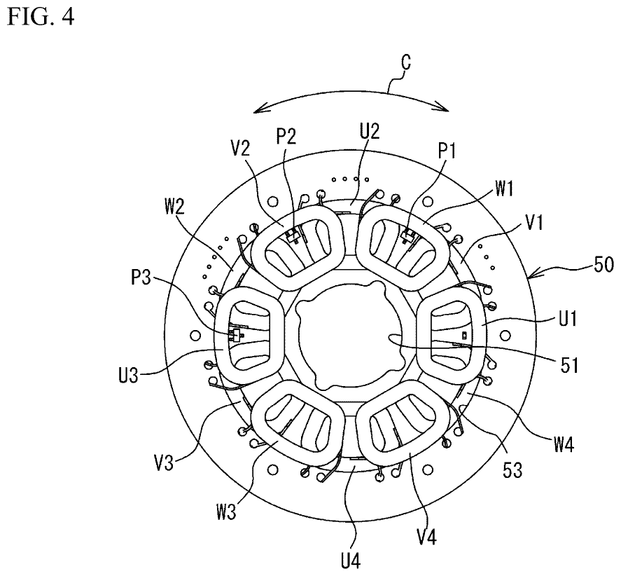

FIG. 2 is a front view of the stator S. FIG. 3 is a front view of the stator S in which sealing resin portion M is omitted. FIG. 4 is a front view of the stator S in which the sealing resin portion M and the reinforcing plate 60 are omitted. Each of the printed circuit board 50 and the reinforcing plate 60 has a circular shape. The same applies to the blocking member 70.

As illustrated in FIGS. 2 and 3, coils U1, W1, V2, U3, W3, and V4 embedded in the sealing resin portion M are held in the reinforcing plate 60 at intervals of 60 degrees in the circumferential direction C. The reinforcing plate 60 is an example of a first substrate. The coils U1, W1, V2, U3, W3, and V4 are examples of first coils. As illustrated in FIG. 4, the coils V1, U2, W2, V3, U4, and W4 are held on the printed circuit board 50 at intervals of 60 degrees in the circumferential direction C. The printed circuit board 50 is an example of a second substrate. The coils V1, U2, W2, V3, U4, and W4 are examples of second coils. That is, the printed circuit board 50 and the reinforcing plate 60 hold the coils U1 to U4 of U phase, the coils V1 to V4 of V phase, and the coils W1 to W4 of W phase. The coils U1 to U4 are configured by distributed winding. The same applies to the coils V1 to V4 and W1 to W4. The coils U1 to U4, V1 to V4, and W1 to W4 are electrically connected to the printed circuit board 50. The coils U1, V1, W1, U2, V2, W2, U3, V3, W3, U4, V4, and W4 are aligned in the circumferential direction C (counterclockwise in FIG. 4). The coils U1 to U4 are set at intervals of 90 degrees in the circumferential direction C. The coils V1 to V4 are set at intervals of 90 degrees in the circumferential direction C. The coils W1 to W4 are set at intervals of 90 degrees in the circumferential direction C. The number of coils held by the reinforcing plate 60 and the number of coils held by the printed circuit board 50 are the same six.

As illustrated in FIGS. 2 and 3, the coils U1, W1, V2, U3, W3, and V4 are embedded in the sealing resin portion M in a state of being fitted into holes 63 of the reinforcing plate 60, respectively. This reinforces the coils. The holes 63 are an example of first holes. The hole 63 is continuously formed with notches 64 and 65 for allowing lead-out wires from the coils. The sealing resin portion M is also formed in the notches 64 and 65. As illustrated in FIG. 4, the coils V1, U2, W2, V3, U4, and W4 are held so as to be each fitted into holes 53 of the printed circuit board 50. The holes 53 are an example of second holes. Although not illustrated in FIG. 4, the coil in the hole 53 is embedded in the sealing resin portion M. Therefore, the strength of these coils is secured. In this way, the sealing resin portion M is filled in the hole 63, the notches 64 and 65, and the hole 53 partially overlapping with these in the axial direction A, together with the held coil. The sealing resin portion M will be described in detail later.

As illustrated in FIG. 4, the coil U1 is spaced apart from the coils W4 and V1 in the axial direction A and partially overlaps them in the axial direction A. The coil W1 is spaced apart from the coils V1 and U2 in the axial direction A and partially overlaps them in the axial direction A. The coil V2 is spaced apart from the coils U2 and W2 in the axial direction A and partially overlaps them in the axial direction A. The coil U3 is spaced apart from the coils W2 and V3 in the axial direction A and partially overlaps them in the axial direction A. The coil W3 is spaced apart from the coils V3 and U4 in the axial direction A and partially overlaps them in the axial direction A. The coil V4 is spaced apart from the coils U4 and W4 in the axial direction A and partially overlaps them in the axial direction A. The coil V1 is spaced apart from the coils U1 and W1 in the axial direction A and partially overlaps them in the axial direction A. The coil U2 is spaced apart from the coils W1 and V2 in the axial direction A and partially overlaps them in the axial direction A. The coil W2 is spaced apart from the coils V2 and U3 in the axial direction A and partially overlaps them in the axial direction A. The coil V3 is spaced apart from the coils U3 and W3 in the axial direction A and partially overlaps them in the axial direction A. The coil U4 is spaced apart from the coils W3 and V4 in the axial direction A and partially overlaps them in the axial direction A. The coil W4 is spaced apart from the coils V4 and U1 in the axial direction A and partially overlaps them in the axial direction A. Thus, the axial gap motor 1 is prevented from being increased in size in the axial direction A.

As illustrated in FIG. 4, each of the coils U1 to U4, V1 to V4, and W1 to W4 is wound in a frame shape. This ensures the strength of these coils. The coils U1 to U4, V1 to V4, and W1 to W4 have the same shape. The winding work of these coils is the same, and the work is easy. In addition, the coils are easy to handle during assembly.

As illustrated in FIG. 4, position sensors P1, P2, and P3 are surrounded by the coils W1, V2, and U3, respectively, and are provided on the printed circuit board 50. In this way, the position sensors P1 to P3 are prevented from interfering with the coils W1, V2, and U3, respectively. As a result, the installation areas of the coils U1 to U4, V1 to V4, and W1 to W4 are secured. Note that the position sensors P1 to P3 are Hall elements.

As illustrated in FIG. 4, the position sensor P1 is disposed between the coils V1 and U2 adjacent to each other in the circumferential direction C. The position sensor P2 is disposed between the coils U2 and W2 adjacent to each other in the circumferential direction C. The position sensor P3 is disposed between the coils W2 and V3 adjacent to each other in the circumferential direction C. In this way, the dead space on the printed circuit board 50 is effectively utilized.

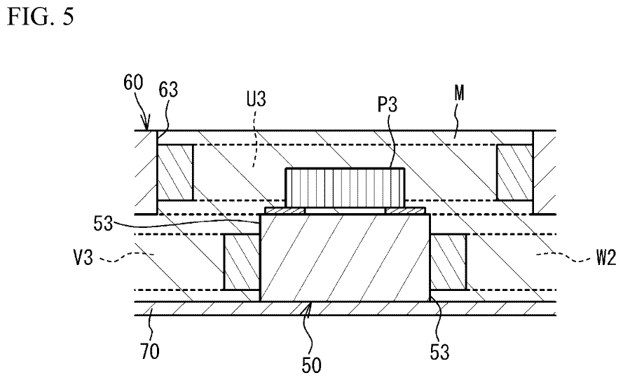

FIG. 5 is a sectional view taken along line A-A of FIG. 2. The position sensor U3 surrounded by the coil P3 does not protrude from an end surface of the reinforcing plate 60. This ensures a reduction in the thickness of the stator S in the axial direction A. The same applies to the position sensors P1 and P2. The coil U3 is disposed in the hole 63 so as not to protrude from the end surface of the reinforcing plate 60. Similarly, the coils V3 and W2 are also disposed in the holes 53 so as not to protrude from the end surface of the printed circuit board 50. The same applies to the other coils.

As described above, the coils U1 to U4, V1 to V4, and W1 to W4 are three phase coils. The total number of these coils is an even number of 12. The number of poles of each of the magnetic pole portions 30 and 40 is eight. Thus, the total number of coils is 1.5 times the number of poles.

As another example, the total number of coils may be six, which is an even number, and the number of poles of the magnetic pole portion may be four. In this case, the number of coils of each of the U phase, the V phase, and the W phase is two. For example, three coils may be provided on a printed circuit board, and the remaining three coils may be embedded in the printed circuit board. Again, the total number of coils is 1.5 times the number of poles.

As still another example, the total number of coils may be 18, which is an even number, and the number of poles of the magnetic pole portion may be six. In this case, the number of coils of each of the U phase, the V phase, and the W phase is six. For example, nine coils may be provided on a printed circuit board, and the remaining nine coils may be embedded in the printed circuit board. In this case, the total number of coils is three times the number of poles.

When the coils are wound in a distributed manner, the position sensor is surrounded by one of the coils, and the position sensor is disposed between two other coils that are spaced apart from the one coil in the axial direction A and adjacent to each other in the circumferential direction C, as in the above-described example, the three phase coils may be formed, and the total number of coils may be preferably an even number and 1.5 or 3 times the number of poles. This allows the coil and the position sensor to be arranged at theoretical positions without interference. Further, 1.5 times the number of poles is preferable. This is because, when the number of poles is increased to three times the number of poles, the number of coils required is increased, and the structure is complicated accordingly, which makes the manufacturing difficult.

### [Method for Manufacturing Stator]

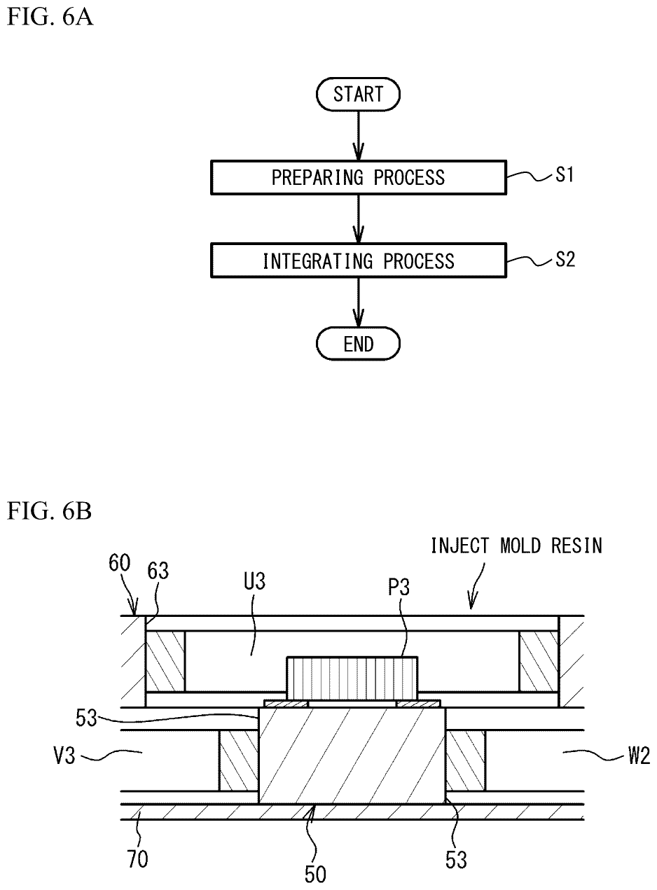

Next, a method of manufacturing the stator S will be described. FIG. 6A is an explanatory view of a method of manufacturing the stator S. The method of manufacturing the stator S includes a preparing process (step S1) and an integrating process (step S2) performed thereafter. The preparation process includes, for example, first and second arrangement processes, first and second conductive connection processes, a stacking process, and a blocking process. In the first arrangement process, the coils V1, U2, W2, V3, U4, and W4 are placed in each of the respective holes 53 in the printed circuit board 50 with position sensors P1 to P3. In the second arrangement process, the coils U1, W1, V2, U3, W3, and V4 are arranged in the respective holes 63 of the reinforcing plate 60. In the first conductive connection process, the coils V1, U2, W2, V3, U4, and W4 are conductively connected to the printed circuit board 50. In the second conductive connection process, the coils U1, W1, V2, U3, W3, and V4 are conductively connected to the printed circuit board 50. In the stacking process, the printed circuit board 50 and the reinforcing plate 60 are positioned in consideration of the relative positions of the coils held by the printed circuit board 50 and the coils held by the reinforcing plate 60, the reinforcing plate 60 is stacked on the printed circuit board 50, and the printed circuit board 50 and the reinforcing plate 60 are, for example, bonded. In the blocking process, the blocking member 70 is placed on the printed circuit board 50 from the opposite side of the reinforcing plate 60 so as to block the plurality of the holes 53, and the printed circuit board 50 and the blocking member 70 are, for example, bonded to each other. Thus, a precursor S′ of the stator S is formed.

The order of the first and second arrangement processes, the first and second conductive connecting processes, the stacking process, and the blocking process is not limited to this. For example, the first arrangement process, the first conductive connection process, the second arrangement process, the second conductive connection process, the blocking process, and the stacking process may be performed in this order. The first arrangement process, the first conductive connection process, the blocking process, the second arrangement process, the second conductive connection process, and the stacking step may be performed in this order. Alternatively, the blocking process, the first arrangement process, the first conductive connection process, the second arrangement process, the second connection process, and the stacking process may be performed in this order. In the blocking process, the printed circuit board 50 and the blocking member 70 may be manufactured simultaneously. For example, the printed circuit board 50 and the blocking member 70 may be integrally manufactured in a state where the blocking member 70 is overlapped with the printed circuit board 50 so as to block the plurality of the holes 53.

In the integrating process, a mold resin is injected into the plurality of the holes 63 of the reinforcing plate 60 of the precursor S′ from the side opposite to the printed circuit board 50 using, for example, a dispenser. FIG. 6B is an explanatory view of the integrating process. FIG. 6B corresponds to FIG. 5. Thus, the mold resin flows from the hole 63 to the notches 64 and 65, and flows to the hole 53 overlapping the hole 63 in the axial direction A, and fills the hole 53 and the notches 64 and 65. Here, the blocking member 70 stacked on the printed circuit board 50 suppresses the mold resin from flowing out from the hole 53 to the outside. When the sealing resin portion M illustrated in FIG. 2 is formed by curing the mold resin, the printed circuit board 50, the reinforcing plate 60, the blocking member 70, the coils U1 to U4, V1 to V4, and W1 to W4, and the position sensors P1 to P3 are integrated. This ensures the strength of the stator S.

In this way, the blocking member 70 eliminates the need for a mold for exclusive molding for integrating the printed circuit board 50, the reinforcing plate 60, the coils U1 to U4, V1 to V4, and W1 to W4, and the position sensors P1 to P3. Since such a mold is not required, the work of releasing the stator S from the mold after the mold resin is cured is also not required. Therefore, the stator S is manufactured with a suppressed manufacturing cost and a secured strength.

The blocking member 70 is a plate-like member having an insulating property. Since the blocking member 70 has an insulating property, even if any coil and the blocking member 70 come into contact with each other, there is no electrical influence. The blocking member 70 is thinner and lighter than each of the printed circuit board 50 and the reinforcing plate 60. Therefore, the stator S is prevented from being increased in size in the axial direction A, and the weight of the stator S is reduced.

The blocking member 70 may be, for example, an insulating substrate. In this case, the blocking member 70 may be, for example, a rigid printed circuit board having no flexibility or a flexible printed circuit board having flexibility. For example, when the blocking member 70 is a rigid printed circuit board or a flexible printed circuit board, a conductor pattern formed on the board may be electrically connected to any of the coil and the position sensor described above. The blocking member 70 may be an adhesive tape having an insulating property. The blocking member 70 may be a rubber member having an insulating property and elasticity. The blocking member 70 may be a flexible sheet having an insulating property.

A printed circuit board may be used instead of the reinforcing plate 60. For example, the coils U1, W1, V2, U3, W3, and V4 may be electrically connected to the printed circuit board. The coils U1 to U4, V1 to V4, and W1 to W4 may be electrically connected to the printed circuit board, and a reinforcing plate may be used instead of the printed circuit board 50.

At least one of the coils U1 to U4, V1 to V4, and W1 to W4 may be wound around a frame body, and the coil wound around the frame body may be held in the hole 53 or 63 together with the frame body. In this case, it is preferable that an opening is provided in the frame body in order to spread the mold resin around the frame body in the hole 53 or 63 in the integrating process described above.

While the exemplary embodiments of the present disclosure have been illustrated in detail, the present disclosure is not limited to the above-mentioned embodiments, and other embodiments, variations and variations may be made without departing from the scope of the present disclosure.

What is claimed is:

1. A method of manufacturing a stator of an axial gap motor, comprising:
preparing a first substrate including a first hole in which a first coil is disposed, a second substrate including a second hole in which a second coil is disposed, the second substrate being stacked on the first substrate such that the second hole at least partially overlaps the first hole, and a blocking member being stacked on the second substrate such that the blocking member blocks the second hole from a side opposite to the first substrate; and
integrating the first and second substrates, the first and second coils, and the blocking member by injecting a mold resin into the first and second holes from a side of the first substrate after the preparing.

2. The method of manufacturing the stator of the axial gap motor according to claim 1, wherein
a position sensor for detecting a rotational position of a rotor is provided on a surface of the second substrate facing the first substrate,
the position sensor is located in the first hole and surrounded by the first coil, and
the integrating integrates the first and second substrates, the first and second coils, the blocking member, and the position sensor.

3. The method of manufacturing the stator of the axial gap motor according to claim 2, wherein
at least one of the first and second coils is electrically connected to at least one of the first and second substrates, and
the position sensor is electrically connected to the second substrate.

4. The method of manufacturing the stator of the axial gap motor according to claim 2, wherein
the first substrate includes a plurality of the first holes,
the second substrate includes a plurality of the second holes,
a plurality of the first coils are disposed in the plurality of the first holes, respectively,
a plurality of the second coils are disposed in the plurality of the second holes, respectively,
the position sensor is located between two adjacent second holes and surrounded by any one of the first coils, and
the integrating integrates the first and second substrates, the plurality of the first coils, the plurality of the second coils, the blocking member, and the position sensor.

5. The method of manufacturing the stator of the axial gap motor according to claim 4, wherein
the rotor includes a yoke rotatably supported, and a magnetic pole portion fixed to the yoke and magnetized to have polarities alternately different in a circumferential direction around a rotation axis of the yoke,
each of the plurality of the first coils and the plurality of the second coils is wound by distributed winding,
the plurality of the first coils and the plurality of the second coils are three phase coils, and
a total number of the plurality of the first coils and the plurality of the second coils is an even number, and is 1.5 times or 3 times the number of poles of the magnetic pole portion.

6. The method of manufacturing the stator of the axial gap motor according to claim 1, wherein the blocking member includes an insulating property, and is thinner and lighter than both the first and second substrates.

7. A stator of an axial gap motor, comprising:
a first substrate including a first hole in which a first coil is disposed;
a second substrate including a second hole in which a second coil is disposed, the second substrate being stacked on the first substrate such that the second hole at least partially overlaps the first hole;
a blocking member overlapped with the second substrate so as to block the second hole from a side opposite to the first substrate; and
a sealing resin portion filled in the first and second holes so as to integrate the first and second substrates, the first and second coils, and the blocking member.
